(19) United States
(12) Patent Application Publication
(10) Pub. No.: US 2007/0271988 A1
(43) Pub. Date: Nov. 29, 2007

(54) Method and Device for Fastening a Rivet Nut on a Workpiece

(75) Inventors: Volker Rothermund, Jork (DE); Martin Woiczik, Hamburg (DE)

Correspondence Address: AKERMAN SENTERFITT, P.O. BOX 3188, WEST PALM BEACH, FL, 33402-3188, US

(73) Assignee: DaimierChrysler AG

(21) Appl. No.: 10/587,761

(22) PCT Filed: Jan. 18, 2005
(86) PCT No.: PCT/EP05/00418

§ 371 Date: Jun. 1, 2007

(30) Foreign Application Priority Data
Jan. 29, 2004 (DE) 10 2004 004 384.1

(51) Int. Cl. B23P 19/06

(52) U.S. Cl. 72/391.8

(57) ABSTRACT

The invention relates to a method and a device for fastening a rivet nut (2) on a workpiece (3), in which a hole (5) is punched into this workpiece and the rivet nut (2) is introduced into this hole by its section (14) to be riveted, after which the rivet nut (2) is riveted to the workpiece (3) by means of a riveting tool. To make it possible for the rivet nut (2) to be fastened on a workpiece (3) in a simple and problem-free manner, it is proposed that, after the hole (5) has been punched, the workpiece (3) is fed to a first follow-on tool (13) in which the rivet nut (2) is introduced into the hole (5) by its section (14) to be riveted, the rivet nut (2) in the follow-on tool (13) being aligned with a discharge channel (19) which is arranged in the first follow-on tool (13) below the workpiece (3) and whose diameter is at least as large as the maximum diameter of the rivet nut (2). The rivet nut (2) now inserted in the hole (5) is then riveted in a second follow-on tool (21) designed as a riveting tool.

### CROSS-REFERENCE TO RELATED APPLICATION

This application is a national stage of PCT/EP2005/000418 filed Jan. 18, 2005 and based upon DE 10 2004 004 384.1 filed on Jan. 29, 2004 under the International Convention

### BACKGROUND OF THE INVENTION

1. Field of the Invention

The invention relates to a method for fastening a rivet nut on a workpiece and to a device.

A generic method and a generic device are known from DE 101 17 060 A1. In this document, as shown by FIGS. 5a to f, a bead is stamped into a sheet metal panel and this bead is then perforated in the same tool by feeding in a punching rivet nut. Furthermore, the rivet nut, likewise in the same tool, is fitted into the punched hole by its section to be riveted, after which the sheet metal panel and nut are transferred to a follow-on tool in which the punched nut is riveted to the sheet metal panel as a result of the hole edge being enclosed by means of the rivet nut section to be riveted. Interruptions occur during the production operation if, for example, the sheet metal coil, which is cut into sheet metal panels, has been used up or if the worker operating or in charge of the device needs for whatever reason to shut down the device for a short or long period of time. It may thus occur that after the sheet metal material has been consumed, a further rivet nut is fed to the device at the location at which it is normally inserted into the hole produced in the sheet metal panel. Consequently, the rivet nut is not seated on the sheet metal panel but on the underside of the device. When recharging the device with sheet metal panel material, there results a collision with the rivet nut already fed in at that point. Since a rivet nut is introduced at this location in the conventional manner, the new rivet nut is as it were stacked on the rivet nut already present, whereby, by virtue of the development of force produced by the rivet-introducing device, damage is caused not only to the joint area but also to the rivet-introducing device.

In the event of the worker having interrupted his work, and the rivet nut being already seated in the hole in the sheet metal panel, the tool for introducing the rivet nut will, subsequent to the interruption, attempt to place a new rivet nut at the same location, which likewise results in damage to the joint area and to the tool. If the damage is not detected promptly, the sheet metal panel together with the double nut is fed to the riveting tool, as a result of which the riveting tool, which is set for riveting a single rivet nut, is rendered unusable through the serious damage which results. The replacement of each of the relevant damaged tools is associated with high cost and effort, accompanied by prolonged and costly production downtime.

2. Description of the Related Art

The object on which the invention is based is to develop a generic method such that it is made possible for a rivet nut to be fastened on a workpiece in a simple and problem-free manner. It is also intended to present a device for fastening the rivet nut.

The object is achieved according to the invention by the features with regard to the method and by the features of the device.

### SUMMARY OF THE INVENTION

By virtue of the arrangement and design of a discharge channel in the follow-on tool in which the rivet nut is introduced into the hole produced in the preceding workstation, and as a result of the diameter of the discharge channel being at least as large as the maximum diameter of the rivet nut, unwelcome damage to the tools of the device according to the invention is prevented. If, for example following the consumption of the sheet metal panel material, another rivet nut is deposited at the location at which the first follow-on tool normally introduces the rivet nut into the punched hole, the rivet nut drops into the discharge channel, from which it is removed from the contact region of the tools of the device according to the invention. This means that when new sheet metal panel material is charged, the first follow-on tool downstream of the punching device can insert a rivet nut into the hole produced without being impeded. In the other case described above, in which the worker interrupts the operation and the transfer of the sheet metal panel is interrupted, with the inserted rivet nut remaining at the point of introduction in the tool, when the worker resumes the operation with a newly fed-in rivet nut, the first follow-on tool presses the already inserted rivet nut through the hole, causing it to drop into the discharge channel and consequently likewise to be withdrawn from the contact region of the tools of the device. Although the hole is damaged by the first rivet nut being pressed through it, making the sheet metal panel a reject, the tools, i.e. the first follow-on tool and the second follow-on tool, which is designed as a riveting tool, remain unimpaired. Overall, it is made possible for rivet nuts to be fastened on the workpiece, which is represented by the sheet metal panel, in a simple and problem-free manner since the risk of damage to the tools of the device according to the invention is precluded from the outset, resulting in no downtimes for repair purposes or replacement of the damaged tools.

In a particularly preferred development of the invention, the rivet nut in the first follow-on tool is pressed into the hole by the section to be riveted using a punch according to the development of the device according to the invention. This ensures that the rivet nut is provisionally secured to the workpiece, that is to say the sheet metal panel, so that when the workpiece is transferred to the riveting device, that is to say the second follow-on tool, the rivet nut does not get lost and can at the same time be fed with positional accuracy to the riveting tool, thereby guaranteeing tolerance-free riveting at the desired point on the workpiece. It is precisely during the pressing-in operation that the invention proves to be particularly advantageous since it is here that particularly high forces are applied which result in particularly sustained damage to the tool in the event of problems arising during conventional fastening of the rivet nut.

In a preferred development of the invention 3, a bead is stamped on the workpiece at the location of the hole to be produced, by means of a stamping tool of the device according to the invention as a development. On the one hand, the bead reinforces the workpiece particularly at the joint area and, on the other hand, the bead, by way of its conical portion, forms a mating body with the undercut contour of the rivet nut, which means that after the bead has been perforated and the rivet nut pressed in, it is possible during the riveting operation for the hole edge to be better engaged by the rivet nut section to be riveted and thus for the hole edge to be positively enclosed by the rivet nut.

According to a particularly preferred development of the method according to the invention and of the device according to the invention, the stamping operation, as the first operation for fastening the rivet nut, is carried out in the same tool as the subsequent hole-punching operation. Here, the stamping tool and the punching tool are arranged jointly in a combination tool. This considerably minimizes the production tolerance for the relative position of the hole in the bead. Furthermore, integrating two processing steps in one tool is not only very economical in terms of the method but also provides a saving in terms of space requirement.

### BRIEF DESCRIPTION OF THE DRAWINGS

The invention will be explained in more detail below with reference to an exemplary embodiment represented in the drawings, in which:

FIG. 1 shows a workpiece in a composite follow-on tool with a rivet nut in a pressed-in state and a rivet nut in the riveted state,

FIG. 2 is a lateral longitudinal section showing a first follow-on tool of the device according to the invention from FIG. 1 for pressing in the rivet nut and a feeding device of the device according to the invention,

FIG. 3 is a lateral longitudinal section showing a combination tool of the device according to the invention from FIG. 1 following the production of a bead and following a hole-punching operation, and the first follow-on tool from FIG. 2 with the rivet nut in the pressed-in state,

FIG. 4 is a lateral longitudinal section showing a second follow-on tool, used for riveting, of the device according to the invention from FIG. 1 after the rivet nut has been riveted to the workpiece.

### DETAILED DESCRIPTION OF THE INVENTION

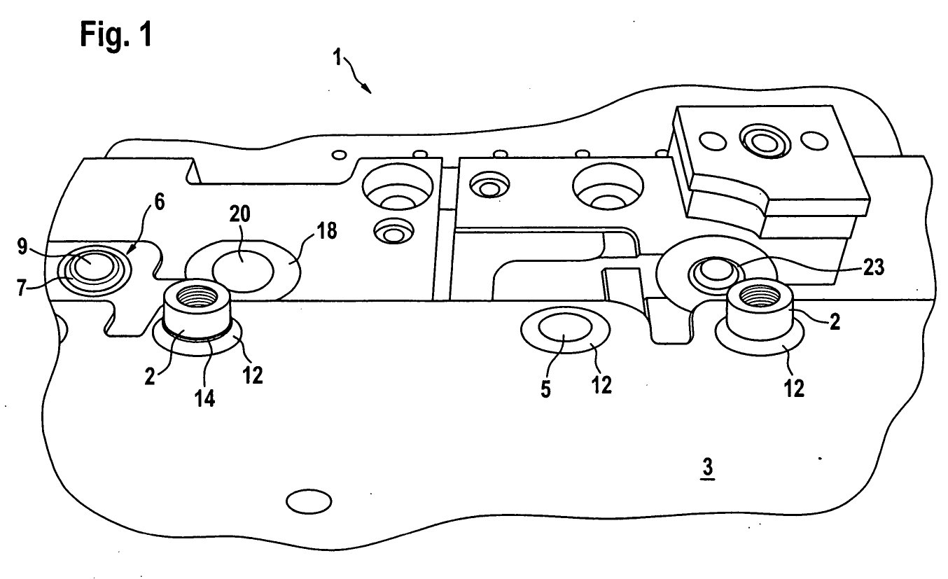

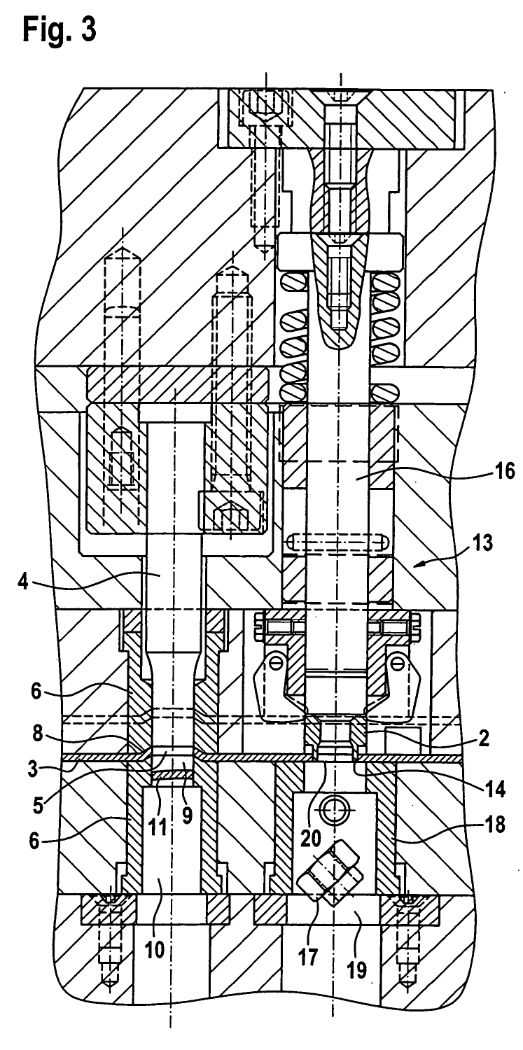

FIG. 1 represents a device 1 for fastening a rivet nut 2 on a workpiece 3, the device 1 being designed as a composite follow-on and progressive-transfer tool. The device 1 comprises a punching tool 4, as can be seen from FIG. 3, which is used to punch a hole 5 into the workpiece 3. The device 1 further includes a stamping tool 6, which is represented in FIG. 1 only by way of its bottom die, this die comprising a raised annular shape 7. The stamping tool 6 is used to carry out the first operation in the method sequence, i.e. stamping a boss-like bead 8 on the workpiece 3, which is formed by a sheet metal panel. The workpiece 3 then remains in the station of the stamping tool 6, since the bead 8 is subjected to punching at the same location by means of the punching tool 4, which is arranged jointly and coaxially with the stamping tool 6 in a combination tool, thereby forming the hole 5. For this purpose, the annular shape 7 of the stamping tool 6 has an opening 9 which is enclosed by the annular shape 7 and which leads into a discharge channel 10 for the slug punched out of the workpiece 3. Following the punching operation, only an annular conical portion 12 remains of the bead 8.

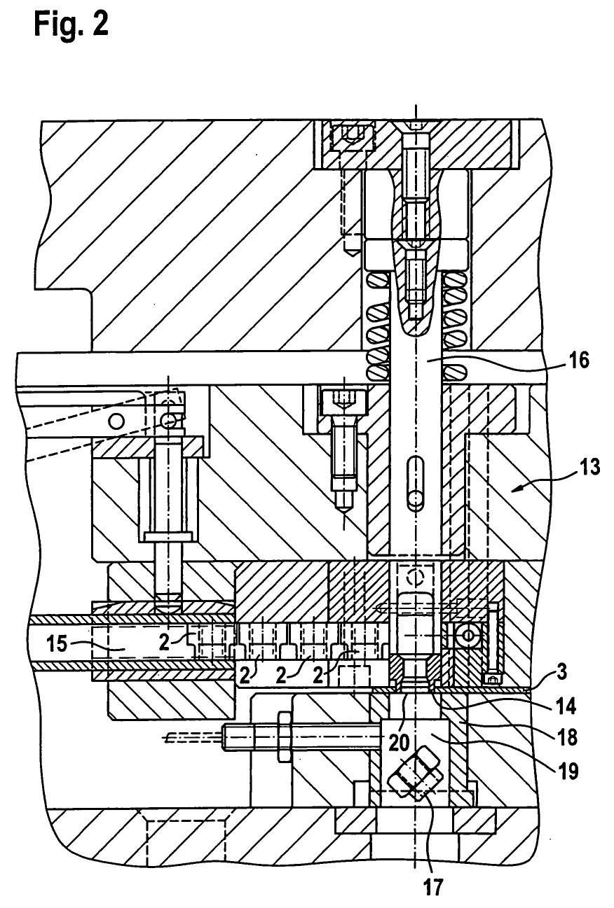

The workpiece 3, together with its stamped and perforated area, is then transferred to a first follow-on tool 13 by means of which the rivet nut 2 is pressed into the hole 5 by a section 14 to be riveted. It is evident here that the diameter of the hole 5 must be slightly smaller than the outside diameter of the section 14 of the rivet nut 2 that is to be riveted. The first follow-on tool 13 is connected to a feeding device 15 via which the nut 2 is transported toward the bead 8 and positioned there. To press in the rivet nut 2, a punch 16 of the first follow-on tool 13 is activated, this punch applying the rivet nut 2 vertically to the workpiece 3. An interruption of the process sequence can result in the occurrence of double nuts at the pressing-in location, that is to say that the rivet nut 2 comes to lie on an already pressed-in rivet nut 17, which inevitably leads to breakage of the first follow-on tool 13 during the pressing-in operation. In order to avoid this according to the invention, as can be seen from FIGS. 2 and 3 a discharge channel 19 is formed below the workpiece 3 in the bottom part 18 of the first follow-on tool 13, the opening 20 of which discharge channel is aligned with the punch 16 and the rivet nut 2 to be fed and, like the discharge channel 19, has a diameter which is at least as large as the maximum diameter of the rivet nut 17, so that when the punch 16 acts on the rivet nut 2, the rivet nut 17 is pressed out of the workpiece 3 and falls through the opening 20 into the discharge channel 19.

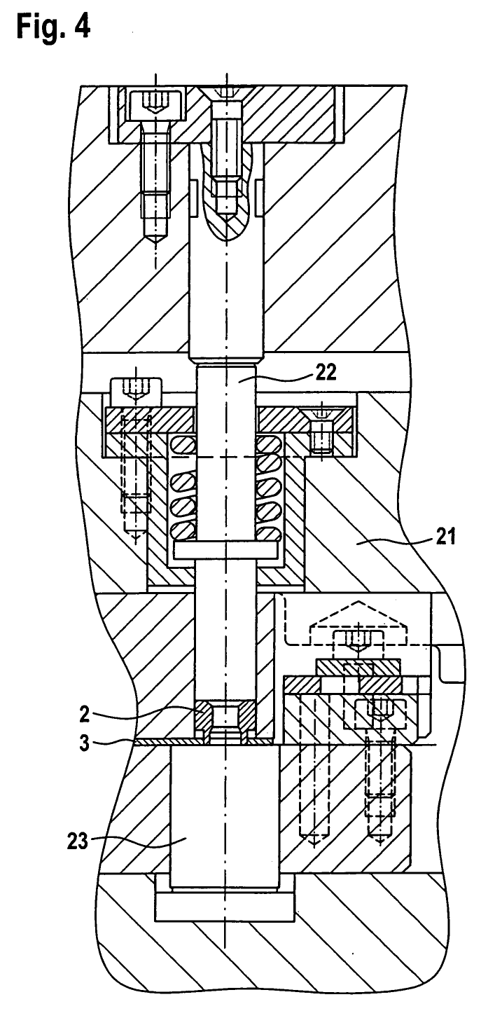

The tool operator then receives a visual or acoustic signal from a sensor device assigned to the discharge channel 19, making him aware that a double nut situation has occurred. The bottom tool 18 here can also be designed as a cutting sleeve, so that when pressing in the rivet nut 2, the rivet nut 17 is cut out together with a portion of the hole edge. Nevertheless, the workpiece 3 then still remains a reject. Finally, the pressed-in rivet nut 2 is transferred with the workpiece to the next workstation in which, as shown in FIGS. 1 and 4, there is arranged a second follow-on tool 21 which is situated separately from the first follow-on tool 13 and is designed as a riveting tool. The second follow-on tool 21, which is composed of a rivet punch 22 and a rivet die 23, is used to expand the section 14 of the rivet nut 2 that is to be riveted and clinch it under the hole edge of the bead 8, with the result that the workpiece 3 is encompassed by the rivet nut 2 at the location of the hole edge and thus riveted.

Now that the invention has been described, We claim:

1. A method for fastening a rivet nut on a workpiece, in which a hole is punched into this workpiece and the rivet nut is introduced into this hole by its section to be riveted, after which the rivet nut is riveted to the workpiece by means of a riveting tool, wherein after the hole (5) has been punched, the workpiece (3) is fed to a first follow-on tool (13) in which the rivet nut (2, 17) is introduced into the hole (5) by its section (14) to be riveted, the rivet nut (2, 17) in the follow-on tool (13) being aligned with a discharge channel (19) which is arranged in the first follow-on tool (13) below the workpiece (3) and whose diameter is at least as large as the maximum diameter of the rivet nut (2, 17), and in that the rivet nut (2, 17) now inserted in the hole (5) is then riveted in a second follow-on tool (21) designed as a riveting tool.

2. The method as claimed in claim 1, wherein the rivet nut (2, 17) in the first follow-on tool (13) is pressed into the hole (5) by the section (14) to be riveted.

3. The method as claimed in claim 1, wherein a bead (8) is stamped on the workpiece (3) at the location of the hole (5) to be produced.

4. The method as claimed in claim 3, wherein the stamping operation, as the first operation for fastening the rivet nut (2, 17), is carried out in the same tool as the subsequent hole-punching operation.

5. A device for fastening a rivet nut on a workpiece, comprising a punching tool for punching a hole into the workpiece and a riveting tool for riveting the rivet nut introduced into the hole, characterized in that the device (1) includes a first follow-on tool (13) which is separate from the punching tool (4) and intended for introducing the rivet nut (2, 17) into the hole (5), the first follow-on tool comprising, below the workpiece (3), a discharge channel (19) which is aligned with the introduced rivet nut (2, 17) and whose diameter is at least as large as the maximum diameter of the rivet nut (2, 17), and in that the riveting tool is a second follow-on tool (21) separate from the punching tool (4) and from the first follow-on tool (13).

6. The device as claimed in claim 5, wherein the first follow-on tool (13) includes a punch (16) by means of which the riveting tool (2, 17) can be pressed into the hole (5) by the section (14) to be riveted.

7. The device as claimed in claim 6, wherein the device (1) includes a stamping tool (6) for stamping a bead (8) at the location of the hole (5) to be produced.

8. The device as claimed in claim 7, wherein the stamping tool (6) and the punching tool (4) are arranged jointly in a combination tool.
